(19) United States
(12) Patent Application Publication
(10) Pub. No.: US 2010/0296587 A1
(43) Pub. Date: Nov. 25, 2010

(54) VIDEO CODING WITH PIXEL-ALIGNED DIRECTIONAL ADAPTIVE INTERPOLATION FILTERS

(75) Inventors: Dmytro Rusanovskyy, Tampere (FI); Kemal Ugur, Tampere (FI); Jani Lainema, Tampere (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/681,779

(22) PCT Filed: Oct. 2, 2008
(86) PCT No.: PCT/IB08/54008

§ 371 Date: Aug. 5, 2010

(30) Foreign Application Priority Data
Oct. 5, 2007 (US) 60978044

(51) Int. Cl. H04N 7/26

(52) U.S. Cl. 375/240.29; 375/E07.193

(57) ABSTRACT

A system and method for implementing an adaptive interpolation filter structure that achieves high coding efficiency with significantly less complexity than more conventional systems. In various embodiments, a set-of integer pixels are defined that are used in the interpolation process to obtain each sub-pixel sample at different locations. Samples at each sub-pixel positions are generated with independent pixel-aligned one-dimensional (1D) adaptive interpolation filters. The filter coefficients are be transmitted to a decoder or stored into a bit stream. At the decoder end, the received filtered coefficients may be used in an interpolation process to create a motion-compensated prediction.

### FIELD OF THE INVENTION

The present invention relates generally to video coding. More particularly, the present invention relates to interpolation processes for sub-pixel pixel locations in motion-compensated prediction in video coding.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Motion Compensated Prediction (MCP) is a technique used in video compression standards to reduce the size of an encoded bitstream. In MCP, a prediction for a current frame is formed using one or more previous frames, and only the difference between the original frame(s) and the prediction signal is encoded and sent to the decoder. The prediction signal is formed by first dividing the frame into blocks, and then searching for a best match in the reference frame(s) for each block. Using this process, the motion of the block relative to the reference frame(s) is determined, and this motion information is coded into the bitstream as motion vectors (MV). A decoder is able to reconstruct the exact prediction by decoding the motion vector data embedded in the bitstream.

The motion vectors are not limited to having full-pixel accuracy, but could have fractional pixel accuracy as well. In other words, the motion vectors can point to fractional pixel locations of a reference image. In order to obtain the samples at fractional pixel locations, interpolation filters are used in the MCP process. Current video coding standards describe how the decoder should obtain samples at fractional pixel accuracy by defining an interpolation filter. The recent H.264/Advanced Video Coding (AVC) video coding standard supports the use of motion vectors with up to quarter pixel accuracy. In H.264/AVC, half pixel samples are obtained by use of a symmetric-separable 6-tap filter, and quarter pixel samples are obtained by averaging the nearest half or full pixel samples. The interpolation filter used in the H.264/AVC standard is discussed, for example, in “Interpolation solution with low encoder memory requirements and low decoder complexity,” Marta Karczewicz, Antti Hallapuro, Document VCEG-N31, ITU-T VCEG12th meeting, Santa Barbara, USA, 24-27 Sep., 2001.

The coding efficiency of a video coding system can be improved by adapting the interpolation filter coefficients at each frame so that the non-stationary properties of the video signal are more accurately captured. In this approach, the video encoder transmits the filter coefficients as side information to the decoder. Another proposed system involves using two-dimensional non-separable 6×6-tap Wiener adaptive interpolation filters (2D-AIF). This system, which is described in “Motion and Aliasing-Compensated Prediction Using a Two-dimensional Non-Separable Adaptive Wiener Interpolation Filter,” Y. Vatis, B. Edler, D. T. Nguyen, J. Ostermann, Proc. ICIP 2005, Genova, Italy, September 2005, reportedly outperforms the standard H.264/AVC filter and has been included in the International Telecommunications Union Telecommunication Standardization Sector (ITU-T) Video Coding Experts Group-Key Technical Area (VCEG-KTA) reference video coding software.

The use of an adaptive interpolation filter in the VCEG-KTA encoder requires two encoding passes for each coded frame. During the first encoding pass, which is performed with the standard H.264 interpolation filter, motion predication information is collected. Subsequently, for each fractional quarter-pixel position, an independent filter is used and the coefficients of each filter are calculated analytically by minimizing the prediction-error energy. FIG. 1, for example, shows a number of example quarter-pixel positions, identified as {a}-{o}, positioned between individual full-pixel positions {C3}, {C4}, {D3} and {D4}. After the coefficients of the adaptive filter are found, the reference frame is interpolated with this filter and the frame is encoded.

### SUMMARY OF THE INVENTION

Various embodiments provide a system and method for implementing an adaptive interpolation filter structure that achieves high coding efficiency with significantly less complexity than more conventional systems. In various embodiments, a set-of integer pixels are defined that are used in the interpolation process to obtain each sub-pixel sample at different locations. Samples at each sub-pixel positions are generated with independent pixel-aligned one-dimensional (1D) adaptive interpolation filters. The resulting filter coefficients are transmitted to a decoder or stored into a bitstream. At the decoder end, the received filtered coefficients may be used in an interpolation process to create a motion-compensated prediction.

The various embodiments serve to improve compression efficiency for modern video codecs using the motion compensated prediction with fractional-pixel accuracy of motion vectors. When integrated into the H.264 video codec, these embodiments outperform the standard H.264 arrangement with a non-adaptive interpolation filter in terms of coding efficiency, while only adding a negligible effect to the decoder complexity. When compared to other two-dimensional adaptive interpolation filter arrangements, a significant reduction of the interpolation complexity is achieved, again with a nearly negligible adverse effect on the coding efficiency.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a representation showing a pixel/sub-pixel arrangement including a specified pixel/sub-pixel notation;

FIG. 2 is an overview diagram of a system within which various embodiments of the present invention may be implemented;

FIG. 3 is a representation showing an interpolation filter alignment according to various embodiments;

FIG. 4 is a flow chart showing a sample implementation of various general embodiments of the present invention;

FIG. 5 is a perspective view of an electronic device that can be used in conjunction with the implementation of various embodiments of the present invention; and

FIG. 6 is a schematic representation of the circuitry which may be included in the electronic device of FIG. 5.

### DETAILED DESCRIPTION OF THE PREFERRED EMBODIMENTS

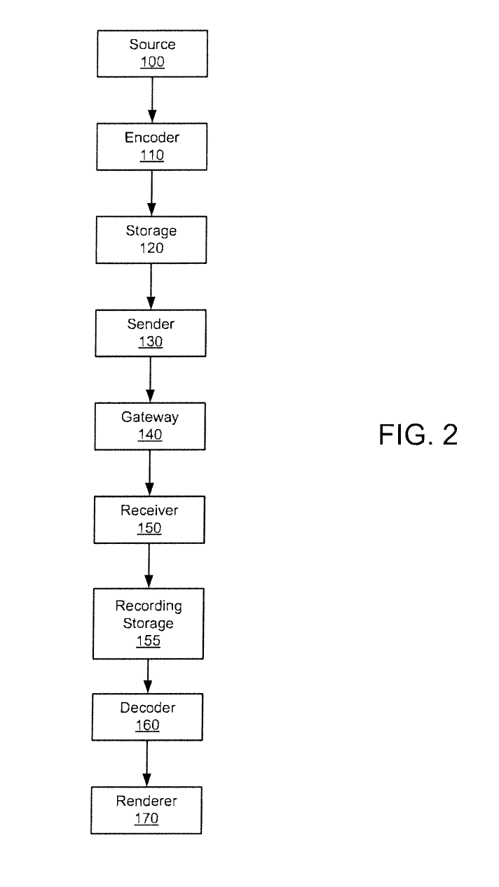

FIG. 2 is a graphical representation of a generic multimedia communication system within which various embodiments of the present invention may be implemented. As shown in FIG. 2, a data source 100 provides a source signal in an analog, uncompressed digital, or compressed digital format, or any combination of these formats. An encoder 110 encodes the source signal into a coded media bitstream. It should be noted that a bitstream to be decoded can be received directly or indirectly from a remote device located within virtually any type of network. Additionally, the bitstream can be received from local hardware or software. The encoder 110 may be capable of encoding more than one media type, such as audio and video, or more than one encoder 110 may be required to code different media types of the source signal. The encoder 110 may also get synthetically produced input, such as graphics and text, or it may be capable of producing coded bitstreams of synthetic media. In the following, only processing of one coded media bitstream of one media type is considered to simplify the description. It should be noted, however, that typically real-time broadcast services comprise several streams (typically at least one audio, video and text sub-titling stream). It should also be noted that the system may include many encoders, but in FIG. 2 only one encoder 110 is represented to simplify the description without a lack of generality. It should be further understood that, although text and examples contained herein may specifically describe an encoding process, one skilled in the art would understand that the same concepts and principles also apply to the corresponding decoding process and vice versa.

The coded media bitstream is transferred to a storage 120. The storage 120 may comprise any type of mass memory to store the coded media bitstream. The format of the coded media bitstream in the storage 120 may be an elementary self-contained bitstream format, or one or more coded media bitstreams may be encapsulated into a container file. Some systems operate “live”, i.e. omit storage and transfer coded media bitstream from the encoder 110 directly to the sender 130. The coded media bitstream is then transferred to the sender 130, also referred to as the server, on a need basis. The format used in the transmission may be an elementary self-contained bitstream format, a packet stream format, or one or more coded media bitstreams may be encapsulated into a container file. The encoder 110, the storage 120, and the server 130 may reside in the same physical device or they may be included in separate devices. The encoder 110 and server 130 may operate with live real-time content, in which case the coded media bitstream is typically not stored permanently, but rather buffered for small periods of time in the content encoder 110 and/or in the server 130 to smooth out variations in processing delay, transfer delay, and coded media bitrate.

The server 130 sends the coded media bitstream using a communication protocol stack. The stack may include, but is not limited to, Real-Time Transport Protocol (RTP), User Datagram Protocol (UDP), and Internet Protocol (IP). When the communication protocol stack is packet-oriented, the server 130 encapsulates the coded media bitstream into packets. For example, when RTP is used, the server 130 encapsulates the coded media bitstream into RTP packets according to an RTP payload format. Typically, each media type has a dedicated RTP payload format. It should be again noted that a system may contain more than one server 130, but for the sake of simplicity, the following description only considers one server 130.

The server 130 may or may not be connected to a gateway 140 through a communication network. The gateway 140 may perform different types of functions, such as translation of a packet stream according to one communication protocol stack to another communication protocol stack, merging and forking of data streams, and manipulation of data streams according to the downlink and/or receiver capabilities, such as controlling the bit rate of the forwarded stream according to prevailing downlink network conditions. Examples of gateways 140 include MCUs, gateways between circuit-switched and packet-switched video telephony, Push-to-talk over Cellular (PoC) servers, IP encapsulators in digital video broadcasting-handheld (DVB-H) systems, or set-top boxes that forward broadcast transmissions locally to home wireless networks. When RTP is used, the gateway 140 is called an RTP mixer or an RTP translator and typically acts as an endpoint of an RTP connection.

The system includes one or more receivers 150, typically capable of receiving, de-modulating, and de-capsulating the transmitted signal into a coded media bitstream. The coded media bitstream is transferred to a recording storage 155. The recording storage 155 may comprise any type of mass memory to store the coded media bitstream. The recording storage 155 may alternatively or additively comprise computation memory, such as random access memory. The format of the coded media bitstream in the recording storage 155 may be an elementary self-contained bitstream format, or one or more coded media bitstreams may be encapsulated into a container file. If there are many coded media bitstreams, such as an audio stream and a video stream, associated with each other, a container file is typically used and the receiver 150 comprises or is attached to a container file generator producing a container file from input streams. Some systems operate “live,” i.e., omit the recording storage 155 and transfer coded media bitstream from the receiver 150 directly to the decoder 160. In some systems, only the most recent part of the recorded stream, e.g., the most recent 10-minute excerption of the recorded stream, is maintained in the recording storage 155, while any earlier recorded data is discarded from the recording storage 155.

The coded media bitstream is transferred from the recording storage 155 to the decoder 160. If there are many coded media bitstreams, such as an audio stream and a video stream, associated with each other and encapsulated into a container file, a file parser (not shown in the figure) is used to decapsulate each coded media bitstream from the container file. The recording storage 155 or a decoder 160 may comprise the file parser, or the file parser is attached to either recording storage 155 or the decoder 160.

The codec media bitstream is typically processed further by a decoder 160, whose output is one or more uncompressed media streams. Finally, a renderer 170 may reproduce the uncompressed media streams with a loudspeaker or a display, for example. The receiver 150, recording storage 155, decoder 160, and renderer 170 may reside in the same physical device or they may be included in separate devices.

Communication devices according to various embodiments of the present invention may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device involved in implementing various embodiments of the present invention may communicate using various media including, but not limited to, radio, infrared, laser, cable connection, and the like.

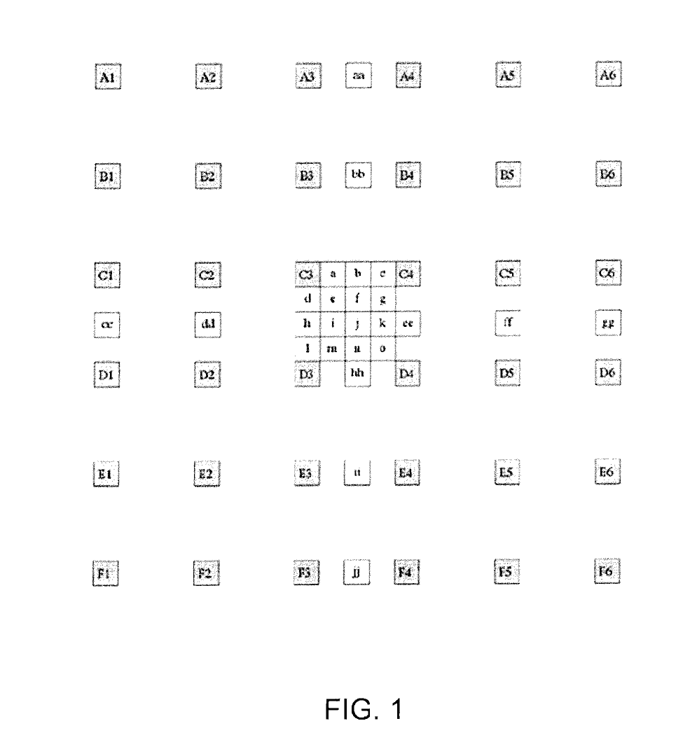

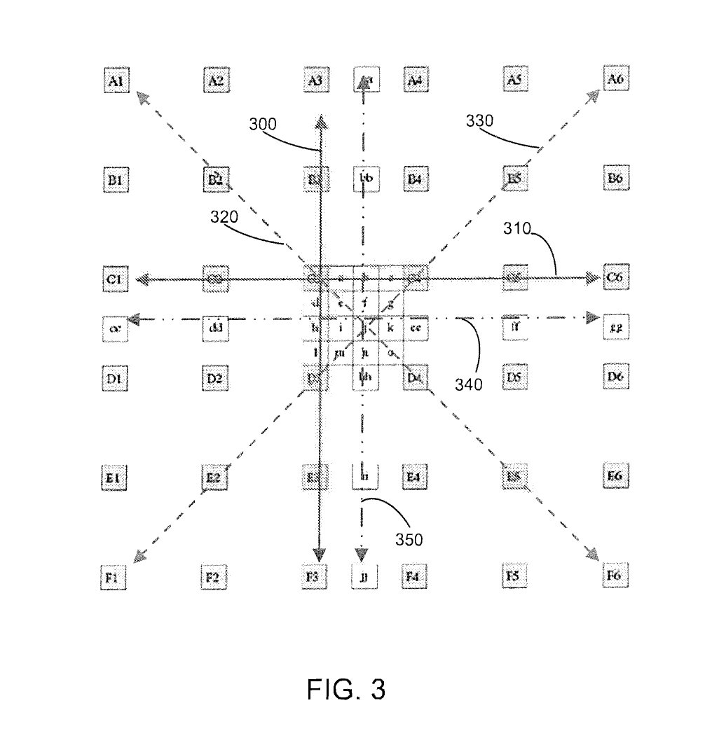

Various embodiments provide for an adaptive interpolation filter structure that achieves a high level of coding efficiency with significantly lower level of complexity than conventional arrangements. According to various embodiments, a set-of integer pixels are defined that are used in the interpolation process in order to obtain each sub-pixel sample at different locations. As discussed previously, FIG. 1 denotes a series of sub-pixel positions {a}-{o} to be interpolated between pixels {C3}, {C4}, {D3} and {D4}, with interpolation being performed up to the quarter pixel level. Samples at each of the sub-pixel positions are generated with independent pixel-aligned 1D adaptive interpolation filters. For the example representation depicted in FIG. 1, the structure of the interpolation filter used to obtain these sub-pixel samples are defined as follows, with FIG. 3 showing the interpolation filter alignment according for the arrangement depicted in FIG. 1.

Sub-pixel samples which are horizontally or vertically aligned with integer pixels positions, for example the samples at positions {a}, {b}, {c}, {d}, {h} and {l} in FIG. 1, are computed with one dimensional horizontal or vertical adaptive filters, respectively. Assuming the utilized filter is 6-tap, this is indicated as follows:
{a,b,c}=fun (C1,C2,C3,C4,C5,C6) {d,h,l}=fun (A3,B3,C3,D3,E3,F3)

In other words, each of the values of {a}, {b} and {c} is a function of {C1}-{C6} in this example. In FIG. 3, a solid horizontal arrow 310 and a solid vertical arrow 300 indicate the filter alignment for the horizontally and vertically aligned pixels above.

Again referring to FIG. 3, sub-pixel samples {e}, {g}, {m} and {o} are diagonally aligned with integer pixel positions. Adaptive interpolation filters for {e} and {o} utilize image pixels that are diagonally aligned in the northwest-southeast (NW-SE) direction, while sub-pixel samples {m} and {g} are diagonally aligned in the northeast-southwest (NE-SW) direction. If 6-tap filtering is assumed, then the filtering operations for these sub-pixel locations are indicated as follows:
{e,o}=fun (A1,B2,C3,D4,E5,F6),
{m,g}=fun (F1,E2,D3,C4,B5,A6)

In FIG. 3, a first regularly-dashed arrow 320 (for the NW-SE direction) and a second regularly-dashed arrow 330 (for the NE-SW direction) show the filter alignment for the above cases.

In contrast to the sub-pixel locations discussed above, the sub-pixel samples located at positions {f}, {i}, {k} and {n} in FIG. 3 are not aligned with integer pixel samples in the horizontal, vertical or diagonal directions. Therefore, these samples are obtained using the half-pixel samples {aa}, {bb}, {cc}, . . . , {jj}, as well as half-pixel samples such as {b} and {h}. If 6-tap filtering is assumed, then the filtering operations for these sub-pixel locations are indicated as follows:
{f,n}=fun (aa,bb,b,hh,ii,jj),
{i,k}=fun (cc,dd,h,ee,ff,gg).

The alignment of these filters is shown in FIG. 3 via a first irregularly dashed arrow 340 (for sub-pixels {i} and {k}) and a second irregularly-dashed arrow 350 (for sub-pixels {f} and {n}). Different methods may be used to obtain the intermediate values {aa}, {bb}, {cc}, . . . , {jj}. In one embodiment, the input values for the filters may be obtained utilizing the same integer-pixel samples as for the diagonally aligned 12-tap filter described above.

The structure of the filters to be used according to various embodiments of the present invention can take a variety of forms. For example, one dimensional filters can be implemented in various ways, either in a 16-bit arithmetic format or a 32-bit arithmetic format.

Referring again to FIG. 1, the 12-tap filter for sub-pixel position {j} could be implemented in various ways. In one particular implementation, the intermediate output values of two 6-tap filters are first calculated in both directions. This is followed by an averaging of the results to obtain sample {j}. In another implementation, the sample {j} can be directly obtained using 12-tap filtering. For this position, it is also possible to simply treat this sample in the same manner as sub-pixel samples {e}, {g}, {m} and {o}, implementing a diagonally adaptive filter using the filter coefficients for the diagonally aligned integer pixel locations in only one direction.

In various embodiments, sample values at the half-pixel locations {b}, {h}, {aa}, {bb}, {cc}, {dd}, {ee}, {ff}, {gg}, {hh}, {ii} and {jj} are necessary for interpolating values for the quarter-pixel positions {f}, {i}, {k} and {n}. Various approaches can be utilized to retrieve samples at these half-pixel locations. One approach involves sample substitution. In sample substitution, sample values at the half-pixel locations participating in {f}, {i}, {k} and {n} filter estimation and interpolation processes are calculated as a function of selected integer-pixel samples in the support area of the filter (e.g., as an average of two samples). In a particular embodiment, the half-pixel values are obtained using the diagonal integer-pixel values as shown in FIG. 3. In each of the half-pixel samples below, the calculated half-pixel sample is an average of the two designated integer-pixel samples:

| | | | |
|---|---|---|---|
| aa = A1 + A6 | bb = B2 + B5 | cc = A1 + F1 | dd = B2 + E2 |
| ee = C4 + D4 | ff = B5 + E5 | gg = A6 + F6 | ii = E2 + E5 |
| jj = F1 + F6 | b = C3 + C4 | h = C3 + D3 | hh = D3 + D4 |

Another method for determining sample values at the half-pixel locations involves static half-pixel processing. In static half-pixel processing, sub-pixel samples {b} and {h} can be interpolated over the entire frame, before conducting filter estimation and interpolation processes, using a predefined filter.

In another embodiment, sample values at the half-pixel locations are not needed to determine values for the quarter sub-pixel samples {f}, {i}, {k} and {n}, instead only utilizing only integer-pixel values. In this method, for example, sub-pixel samples {f}, {i}, {k} and {n} can be obtained utilizing predefined integer-pixel values, avoiding the generation of intermediate samples. More particularly, sub-pixel samples {f}, {i}, {k} and {n} can be calculated from the nearest integer-pixel samples {C3}, {C4}, {D3} and {D4} and two additional location-dependent integer samples. In the situation depicted in FIGS. 1 and 3, {B3} and {B4} would also be used for determining {f}; {C2} and {D2} would also be used for determining {i}; {C5} and {D5} would be used for determining {k}; and {E3} and {E4} would be used for determining {n}. In each case, these samples would be used in addition to integer-pixel samples {C3}, {C4}, {D3} and {D4}. Alternatively the respective sub-pixel samples can be computed using a one-dimensional filter that is diagonally adjusted with an angle that is different than 45 degrees. For example, the sub-pixel location {f} can be computed using integer-pixel samples at {B1}, {B2}, {C3}, {D4}, {E5} and {E6}. A similar structure could be used to determine {i}, {k} and {n}.

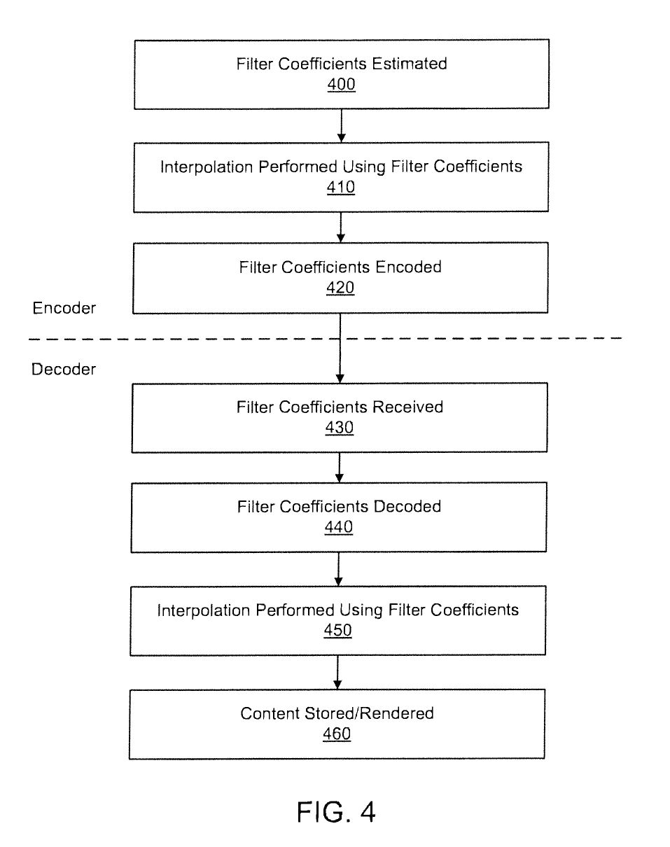

FIG. 4 is a flow chart showing a sample implementation of various general embodiments of the present invention. For video encoding, the process begins at 400 in FIG. 4 with the estimation of filter coefficients. The filter coefficients can be estimated using various algorithms. Algorithms for the analytical computation of Wiener-filter coefficients using the Wiener-Hopf equations can be found, for example, at “Motion and Aliasing-Compensated Prediction Using a Two-dimensional Non-Separable Adaptive Wiener Interpolation Filter,” Y. Vatis, B. Edler, D. T. Nguyen, J. Ostermann, Proc. ICIP 2005, Genova, Italy, September 2005. At 410, the encoder performs an interpolation process to create the motion-compensated prediction. This interpolation process uses the filter coefficients that were estimated at 400. at 420, the encoder encodes content including filter coefficients into a bitstream, for example onto a storage device or for transmission to a remote device such as a decoder. Various methods are known for coding filter coefficients, including those methods discussed in U.S. Publication No. 2003/0169931, published Sep. 11, 2003, for example.

On the decoder side, the decoder can receive the filter coefficients at 430 and, at 440, decode the filter coefficients. At 450, the decoder performs an interpolation process to create the motion-compensated prediction. This interpolation process uses the filter coefficients that were received and decoded at 430 and 440, respectively. The content including the filter coefficients and the generated sub-pixel values can then be stored and/or rendered at 460 as necessary or desired, for example on the display of a device.

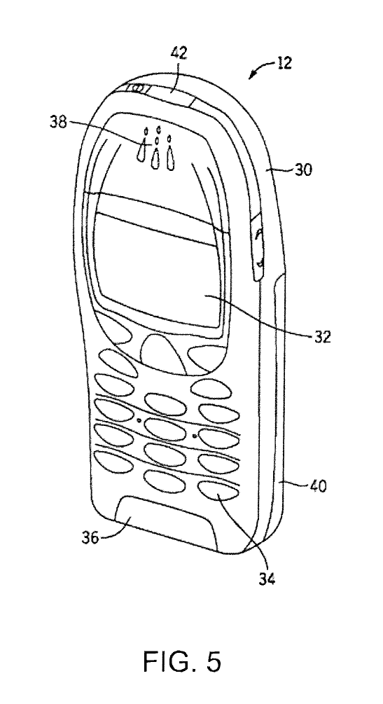

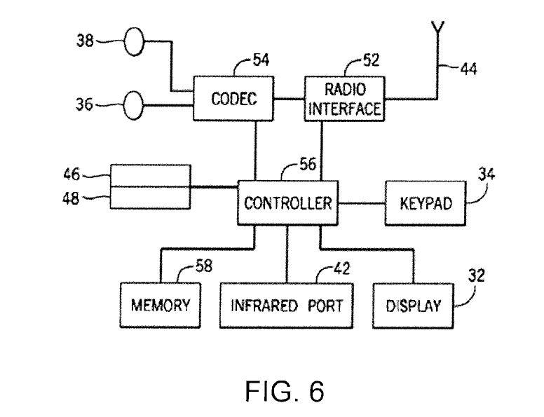

FIGS. 5 and 6 show one representative mobile device 12 within which the present invention may be implemented. It should be understood, however, that the present invention is not intended to be limited to one particular type of electronic device. The mobile device 12 of FIGS. 5 and 6 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment of the invention, a card reader 48, radio interface circuitry 52, codec circuitry 54, a controller 56 and a memory 58. Individual circuits and elements are all of a type well known in the art, for example in the Nokia range of mobile telephones.

The various embodiments described herein is described in the general context of method steps or processes, which may be implemented in one embodiment by a computer program product, embodied in a computer-readable medium, including computer-executable instructions, such as program code, executed by computers in networked environments. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

Software and web implementations of various embodiments can be accomplished with standard programming techniques with rule-based logic and other logic to accomplish various database searching steps or processes, correlation steps or processes, comparison steps or processes and decision steps or processes. It should be noted that the words “component” and “module,” as used herein and in the following claims, is intended to encompass implementations using one or more lines of software code, and/or hardware implementations, and/or equipment for receiving manual inputs.

The foregoing description of embodiments has been presented for purposes of illustration and description. The foregoing description is not intended to be exhaustive or to limit embodiments of the present invention to the precise form disclosed, and modifications and variations are possible in light of the above teachings or may be acquired from practice of various embodiments. The embodiments discussed herein were chosen and described in order to explain the principles and the nature of various embodiments and its practical application to enable one skilled in the art to utilize the present invention in various embodiments and with various modifications as are suited to the particular use contemplated. The features of the embodiments described herein may be combined in all possible combinations of methods, apparatus, modules, systems, and computer program products.

What is claimed is:

1. A method, comprising:
providing filter coefficients for a plurality of integer pixels;
for each of a plurality of sub-pixel locations located between integer pixels, using a directional adaptive interpolation filter to generate a sub-pixel value; and
performing at least one of encoding into a bitstream, decoding, storing and rendering content including the filter coefficients.

2. The method of claim 1, wherein, for each sub-pixel which is aligned in one diagonal direction with integer pixel locations, a diagonally adaptive filter using the filter coefficients for the diagonally aligned integer pixel locations is used to generate the respective sub-pixel value.

3. The method of claim 1, wherein, for each sub-pixel which is aligned in two diagonal directions with integer pixel locations, a diagonally adaptive filter using the filter coefficients for the diagonally aligned integer pixel locations in each direction is used to generate the respective sub-pixel value.

4. The method of claim 1, wherein, for each sub-pixel which is aligned in two diagonal directions with integer pixel locations, a diagonally adaptive filter using the filter coefficients for the diagonally aligned integer pixel locations in one of the directions is used to generate the respective sub-pixel value.

5. The method of claim 1, wherein, for each sub-pixel which is not aligned with any integer pixel locations in a horizontal, vertical or diagonal direction, values for interpolated half-pixels that are aligned with the respective sub-pixel are used in generating the respective sub-pixel value.

6. The method of claim 1, wherein, for each sub-pixel which is not aligned with any integer pixel locations in a horizontal, vertical or diagonal direction, the filter coefficients for a set of pre-defined integer pixels are used to generate the respective sub-pixel value.

7. A computer program product, embodied in a computer-readable medium, comprising computer code configured to perform the processes of claim 1.

8. An apparatus, comprising:
a processor; and
a memory unit communicatively connected to the processor and including:
computer code for providing filter coefficients for a plurality of integer pixels;
computer code for, for each of a plurality of sub-pixel locations located between integer pixels, using a directional adaptive interpolation filter to generate a sub-pixel value; and
computer code for performing at least one of encoding into a bitstream, decoding, storing and rendering content including the filter coefficients.

9. The apparatus of claim 8, wherein, for each sub-pixel which is aligned in one diagonal direction with integer pixel locations, a diagonally adaptive filter using the filter coefficients for the diagonally aligned integer pixel locations is used to generate the respective sub-pixel value.

10. The apparatus of claim 8, wherein, for each sub-pixel which is aligned in two diagonal directions with integer pixel locations, a diagonally adaptive filter using the filter coefficients for the diagonally aligned integer pixel locations in each direction is used to generate the respective sub-pixel value.

11. The apparatus of claim 8, wherein, for each sub-pixel which is aligned in two diagonal directions with integer pixel locations, a diagonally adaptive filter using the filter coefficients for the diagonally aligned integer pixel locations in one of the directions is used to generate the respective sub-pixel value.

12. The apparatus of claim 8, wherein, for each sub-pixel which is not aligned with any integer pixel locations in a horizontal, vertical or diagonal direction, values for interpolated half-pixels that are aligned with the respective sub-pixel are used in generating the respective sub-pixel value.

13. The apparatus of claim 8, wherein, for each sub-pixel which is not aligned with any integer pixel locations in a horizontal, vertical or diagonal direction, the filter coefficients for a set of pre-defined integer pixels are used to generate the respective sub-pixel value.

14. An apparatus, comprising:
means for providing filter coefficients for a plurality of integer pixels;
means for, for each of a plurality of sub-pixel locations located between integer pixels, using a directional adaptive interpolation filter to generate a sub-pixel value; and
means for performing at least one of encoding into a bitstream, decoding, storing and rendering content including the filter coefficients.

15. The apparatus of claim 14, wherein, for each sub-pixel which is not aligned with any integer pixel locations in a horizontal, vertical or diagonal direction, values for interpolated half-pixels that are aligned with the respective sub-pixel are used in generating the respective sub-pixel value.
